(19) United States
(12) Patent Application Publication
(10) Pub. No.: US 2026/0003615 A1
(43) Pub. Date: Jan. 1, 2026

(54) INTEGRATION FLOW SCRIPT OPTIMIZATION USING GENERATIVE MODEL

(71) Applicant: SAP SE, Walldorf (DE)

(72) Inventor: Hui LI, Shanghai (CN)

(21) Appl. No.: 18/756,170

(22) Filed: Jun. 27, 2024

(51) Int. Cl. G06F 9/22

(52) U.S. Cl. CPC G06F 9/223

(57) ABSTRACT

Systems and methods include determination of metadata of remote calls between a plurality of microservices deployed to respective nodes, determination, for each pair of the plurality of microservices, of a total payload size based on metadata of remote calls between the pair of the plurality of microservices, generation of a graph including a vertex associated with each microservice and an edge between each pair of vertices, where each edge is weighted based on the total payload size determined for the pair of microservices associated with the vertices the edge is between, division of the vertices into a plurality of groups based on the graph, at least one group including two or more vertices, and deploy, for each of the plurality of groups, the microservices associated with the vertices of the group to a same node or proximate nodes.

### BACKGROUND

A microservice-based application consists of distinct functions implemented using microservices. Typically, each request directed to a microservice-based application is processed using several microservices. Each microservice is independently accessible and executes in its own computing process in a separate computing system.

Microservices are often implemented in the cloud in order to leverage the redundancy, economies of scale and other benefits provided by cloud platforms. One such benefit is resource elasticity, which allows the computing resources (e.g., CPU power, memory size, and network bandwidth) consumed by a microservice to be efficiently scaled up and scaled down according to the needs of the microservice.

Cloud-based implementations often deploy microservices in containers (e.g., Docker), which are managed by a container orchestration platform (e.g., Kubernetes). A container executes within a pod, and one or more pods are executed within a node. A node may comprise a physical or virtual server.

Large systems may include thousands to millions of microservices and hundreds to thousands of nodes. To reduce network latency, it is desirable to deploy microservices having greater interaction with one another closer together (i.e., in the same node or in nearby nodes (e.g., same rack or zone)) than microservices which have less interaction with one another. Accordingly, system engineers attempt to efficiently deploy microservices to nodes based on locations of the nodes and on the predicted operation of the microservices. This prediction typically lacks quantitative rigor and may therefore poorly reflect the actual operation of the microservices. Consequently, network latency is sub-optimal.

Systems are desired for efficient determination of a microservice deployment distribution.

### BRIEF DESCRIPTION OF THE DRAWINGS

FIG. 1 illustrates a microservice-based system according to some embodiments.

FIG. 2 illustrates a node executing pods according to some embodiments.

FIG. 3 illustrates collection of call metadata according to some embodiments.

FIG. 4 is a flow diagram of a process to deploy microservices to nodes according to some embodiments.

FIG. 5 illustrates a call sequence within a microservice-based system according to some embodiments.

FIG. 6 is a tabular representation of call metadata according to some embodiments.

FIG. 7 is a tabular representation of total payload sizes per service pair according to some embodiments.

FIG. 8 is a matrix of total payload sizes per microservice pair according to some embodiments.

FIG. 9 is a graph of microservices and total payload sizes per microservice pair according to some embodiments.

FIG. 10 is a flow diagram of a process to determine deployment groups of microservices according to some embodiments.

FIG. 11 is a tabular representation of total weights of cutting edges of a minimum source-sink cut per microservice pair according to some embodiments.

FIG. 12 comprises subgraphs of microservices and total payload sizes per microservice pair according to some embodiments.

FIG. 13 is a tabular representation of total weights of cutting edges of a minimum source-sink cut per microservice pair according to some embodiments.

FIG. 14 comprises subgraphs of microservices and total payload sizes per microservice pair according to some embodiments.

FIG. 15 is a view of an operator interface for modifying and deploying groups of microservices according to some embodiments.

FIG. 16 illustrates a cloud-based architecture according to some embodiments.

### DETAILED DESCRIPTION

The following description is provided to enable any person in the art to make and use the described embodiments. Various modifications, however, will remain readily-apparent to those in the art.

Some embodiments facilitate the determination of a distribution of microservice deployments. The terms service and microservice are used interchangeably herein. The determination of a distribution of microservice deployments may be based on a total payload size of communications between respective pairs of microservices over a period of time. Moreover, the determination may be based on a graph representing the total payload sizes and respective pairs of microservices, and on an algorithm for dividing the graph into groups of microservices. In some embodiments, microservices belonging to the same group may be deployed proximate to one another. In some embodiments, the payload sizes are used as a proxy to determine latency of requests and responses between microservices. In this way, microservices can be grouped more efficiently such that no one group of microservices becomes a latency bottleneck in the system.

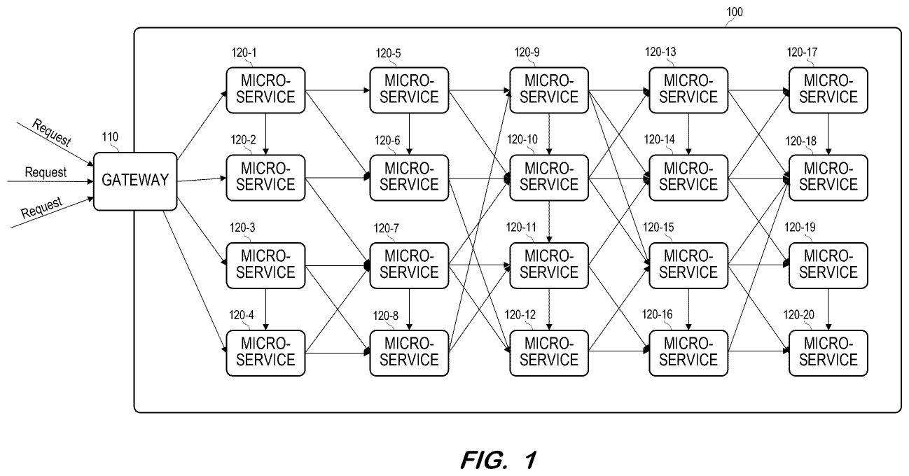

FIG. 1 illustrates a microservice-based system according to some embodiments. The illustrated components of FIG. 1 and of the other figures described herein may be implemented using any suitable combinations of computing hardware and/or software that are or become known. Such combinations may include on-premise servers, cloud-based servers, and/or elastically-allocated virtual machines. In some embodiments, two or more components are implemented by a single computing device.

System 100 may comprise any number of hardware and software components which may provide functionality to one or more users (not shown). In the present example, system 100 includes gateway 110 providing routing of incoming requests associated with one or more applications, as well as authentication, authorization, and load balancing.

System 100 also includes microservices 120-1 through 120-20. Each of microservices 120-1 through 120-20 runs in a separate execution environment (e.g., a separate process in a separate computing system). Each of microservices 120-1 through 120-20 may communicate with one or more other ones of microservices 120-1 through 120-20 using lightweight network communication mechanisms such as a resource Application Programming Interface (API) via Hyper Text Transfer Protocol (HTTP) request-response messages, but embodiments are not limited thereto.

Execution of microservices 120-1 through 120-20 is orchestrated to provide functionality of an application as is known in the art. Different types of incoming requests may result in execution of different sequences of microservices 120-1 through 120-20. For example, gateway 110 receives an external request (e.g., an API call) of a first type from a client device. Gateway 110 performs required authentication and authorization functions and determines, based on its configuration and logic, that the request should be forwarded to microservice 120-3. The request of the first type is then processed by executing, in sequence, microservices 120-3, 120-8, 120-11, 120-16 and 120-20. If the incoming request is of a second type, it may be processed by executing microservices 120-2, 120-6, 120-10, 120-11, 120-12 and 120-15 sequentially.

Execution of a sequence of microservices consists of inter-microservice remote calls. With respect to the first example above, microservice 120-3 transmits a request to microservice 120-8 and receives a response therefrom. Prior to providing the response to microservice 120-3, microservice 120-8 transmits a request to microservice 120-11 and receives a response in return. Again, prior to providing the response to microservice 120-8, microservice 120-11 transmits a request to microservice 120-16 and receives a response therefrom. The requests/responses between microservices may therefore be “nested” in some embodiments.

Cloud environments generally provide systems to elastically allocate computing resources to virtual machines based on demand. In one example, a container orchestration platform manages containers in which instances of a microservice are deployed. Resources may be allocated or deallocated from the microservice by increasing or decreasing the number of containers based on demand.

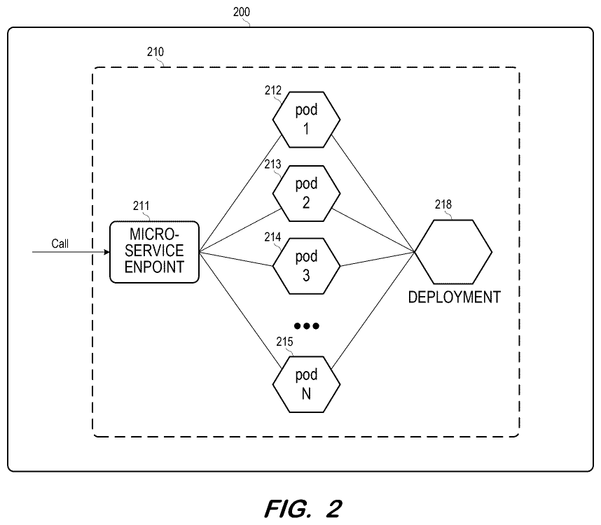

FIG. 2 illustrates node 210 deployed in container orchestration platform 200 such as but not limited to Kubernetes. Node 210 is a virtual or a physical machine and contains N pods 212-215. Each of pods 212-215 includes one or more containers, each of which may independently provide the functionality of microservice 210. According to some embodiments, microservice endpoint 211 receives a request from another microservice (or from a gateway) and routes the request to one of pods 212-215 for processing thereby. Deployment component 218 may adjust the number of pods (and, therefore, containers) based on the expected workload of node 210.

Each remote call sent between microservices consists of a request and a response. Each request and response may include a payload as is known in the art. Some embodiments operate to collect the payload size of each request and response sent between microservices. This information may be used as will be described below to determine groups of microservices which should be deployed proximate to one another.

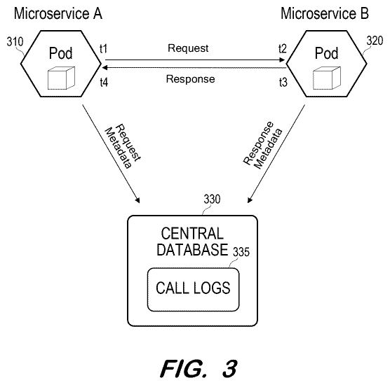

FIG. 3 illustrates collection of remote call metadata according to some embodiments. Pod 310 executes microservice A and pod 320 executes microservice B during runtime. At time t1, microservice A sends a request to microservice B. The request is received at microservice B at time t2. At a later time t3, microservice B sends a response to the request to microservice A. Microservice A receives the response at time t4. As noted above, microservice B may send requests and receive responses from other microservices between time t2 and time t3.

Central database 330 collects metadata describing characteristics of each request and response which travels between microservice A and microservice B. In some embodiments, pod 310 transmits request metadata to central database 330 describing the request sent from microservice A at time t1. The metadata may include, but is not limited to, an identifier of the request source (i.e., microservice A), an identifier of the request target (i.e., microservice B), a size of the request payload, and a transmission time (i.e., t1). Similarly, pod 320 transmits request metadata to database 330 describing the response sent from microservice B at time t3, including an identifier of the response source (i.e., microservice B), an identifier of the response target (i.e., microservice A), a size of the response payload, and a transmission time (i.e., t3).

Central database 330 may similarly receive request and response metadata from all other pods within a microservice system. Such pods may execute microservice A, microservice B, or any other microservice. Central database 330 stores the received metadata within call logs 335. Central database 330 may comprise a component of a platform monitoring component in some embodiments. The platform monitoring component may pull the above-described request and response metadata from pods as is known in the art.

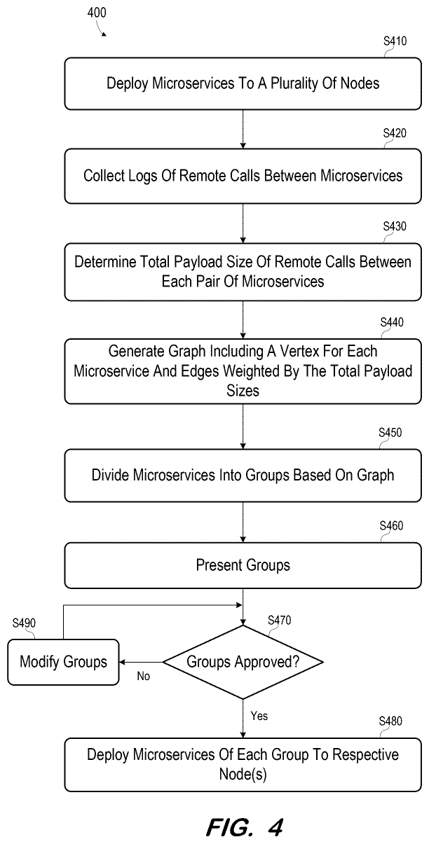

FIG. 4 is a flow diagram of process 400 to deploy microservices to nodes according to some embodiments. Process 400 may be executed by an on-premise or cloud-based administrator system. The administrator system may be an administrator application for a container orchestration platform, which may itself be executed within containers of the container orchestration platform.

Process 400 and the other processes described herein may be performed using any suitable combination of hardware and software. Program code embodying these processes may be stored by any one or more non-transitory tangible media, including a fixed disk, a volatile or non-volatile random-access memory, a DVD, a Flash drive, or a magnetic tape, and executed by any number of processing units, including but not limited to processors, processor cores, and processor threads. Such processors, processor cores, and processor threads may be implemented by a virtual machine provisioned in a cloud-based architecture. Embodiments are not limited to the examples described below.

At S410, a plurality of microservices of a system are deployed to a plurality of nodes. The distribution of the deployment of microservices (i.e., the particular nodes to which particular microservices are deployed) may be determined in any conventional manner. This manner may include a developer's informed intuition as to which microservices should be located near to each other. According to some embodiments, two or more microservices may be deployed to the same node. In some embodiments, microservices which are used to process all (or most) requests (e.g., authentication service, authorization service, gateway service) are deployed to their own unique respective nodes.

Next, the system is operated to receive and respond to incoming requests. The requests may be of different types which are served by different sets of deployed microservices. The requests may be intended to simulate traffic received and microservice calls made within a productive environment over a specified time period. During and/or after this operation, logs of remote calls between microservices are collected at S420 as described with respect to FIG. 3.

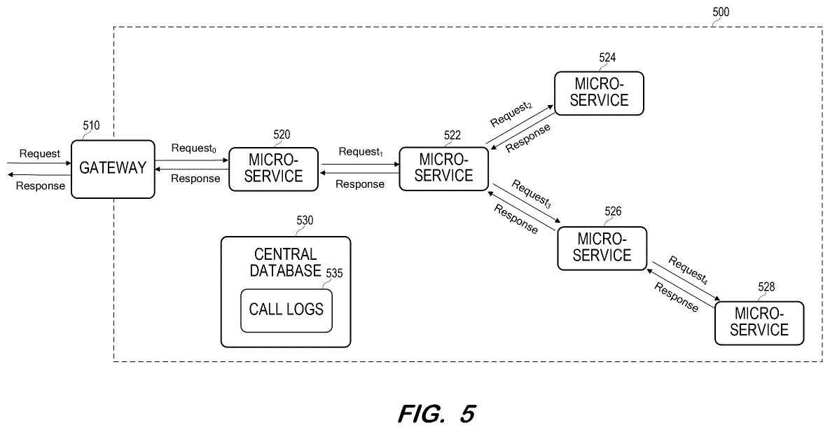

FIG. 5 illustrates microservice system 500 according to some embodiments. System 500 includes gateway 510 and microservices 520, 522, 524, 526 and 528. Microservices 520, 522, 524, 526 and 528 have been deployed to various nodes at S410. System 500 may include other unshown microservices deployed to various nodes, which may include nodes to which one or more of microservices 520, 522, 524, 526 and 528 have been deployed.

During runtime, it is assumed that gateway 510 receives an incoming request of a certain type. Gateway 510 routes the request to microservice 520 as Request₀. In response, microservice 520 calls microservice 522 with Request₁, microservice 522 calls microservice 524 with Request₂ and calls microservice 524 with Request₃, and microservice 526 calls microservice 528 with Request₄. Each called microservice returns a response to its caller and a final response is returned to gateway 510 from microservice 520.

Central database 530 collects logs of each remote call (i.e., request and response) illustrated in FIG. 5. These remote calls may be executed many times during the runtime time period in response to the same type of incoming request. Moreover, other sequences of remote calls may be executed in response to other types of incoming requests. These other sequences may include one or more of microservices 520, 522, 524, 526 and 528 and other unshown microservices. All such remote calls are collected within call logs 535 at S420.

Central database 530 may comprise any data storage system which is centrally-available to microservices of system 500, including but not limited to a key-value in-memory database (e.g., a Redis cluster). Central database 530 may store call logs 535 in any suitable format. Central database 530 may also be capable of responding to queries of call logs 535.

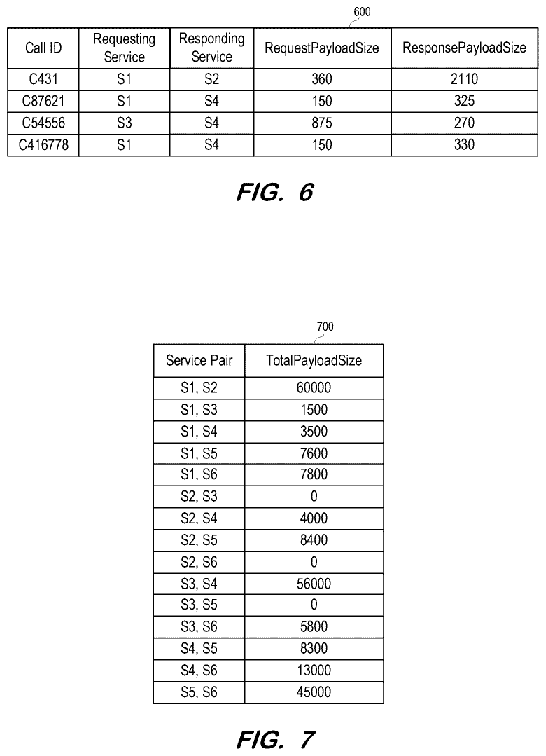

FIG. 6 is a tabular representation of call log 600 according to some embodiments. Call log 600 may store the logs collected at S420, which represent calls made during a period of operation. Each row of call log 600 represents a single remote call, and includes fields Call ID, Requesting Service, Responding Service, RequestPayloadSize and ResponsePayloadSize. Call log 600 may include any other suitable fields and physical arrangement. In some embodiments, each row of call log represents either a request or a response, and indicates the source and target microservices and the payload size.

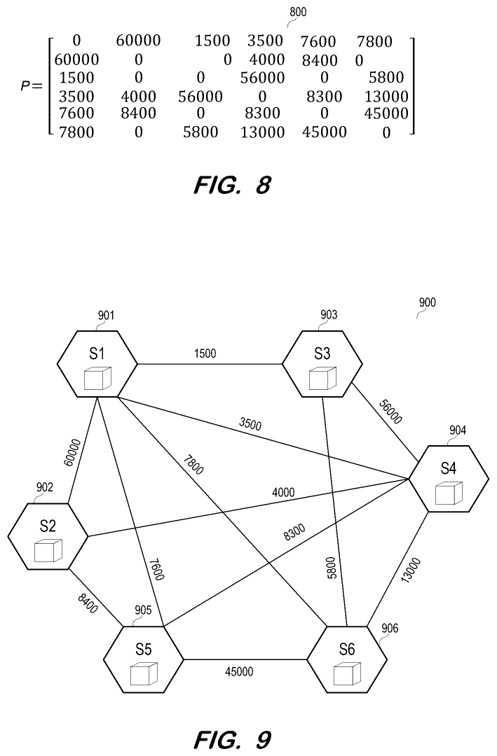

Based on the logs, the total payload size of remote calls between each pair of microservices is determined at S430. The total payload size for a given pair of microservices is equal to the sum of payload sizes of each request and response which passed between the pair of microservices, regardless of the direction of the requests and responses. FIG. 7 shows table 700 of total payload sizes determined at S430 for each pair of microservices in a system which consists of six microservices. FIG. 8 illustrates the total payload sizes of table 700, summarized as matrix 800 in which p_{i,j}=p_{j,i}=the total payload size of the remote calls between serviceᵢ and serviceⱼ. As shown, some of the microservices never communicate with certain other microservices, resulting in a total payload size of zero.

In some embodiments, a network delay of each remote call is also determined based on the collected call logs. Referring to FIG. 3, the network delay of the remote call illustrated in FIG. 3 is equal to (t2-t1)+(t4-t3). From these network delays, aggregate values may be determined such as mean network delay, median network delay, max network delay, 90th percentile network delay, 95th percentile network delay, etc. The aggregate values may be used to evaluate performance of the deployment distribution of S410 against a deployment distribution determined as described herein.

Next, at S440, a graph is generated based on the determined total payload sizes. The graph includes a vertex for each microservice and undirected edges which are weighted by the total payload sizes. Graph 900 of FIG. 9 reflects the microservices and total payload sizes of table 700 and matrix 800. For example, the edge between vertex 901 representing microservice S1 and vertex 902 representing microservice S2 is weighted by the total payload size of the pair S1, S2, i.e., 60000. The edge between vertex 901 representing microservice S1 and vertex 904 representing microservice S4 is weighted by the total payload size of the pair S1, S4, i.e., 3500. Moreover, no edge exists between vertex 902 representing microservice S2 and vertex 903 representing microservice S3 since the total payload size of the pair S2, S3 is zero.

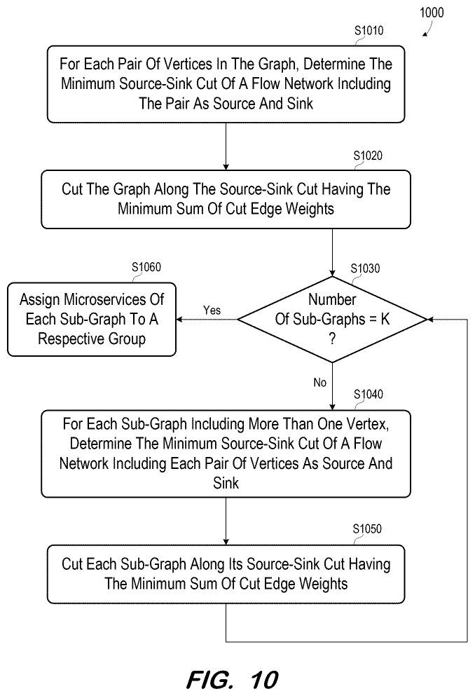

The microservices are divided into groups based on the graph at S450. The division may be based on the edge weights and on any suitable algorithm that is or becomes known. FIG. 10 is a flow diagram of process 1000 to divide the microservices into groups based on the graph at S450 using a minimum K-cut algorithm. The groupings derived at S450, depending on the initial groupings of the microservice environment, may have an anticipated lower overall latency based on reallocation of microservices to different groups to more efficiently distribute the payloads.

At S1010, a pair of vertices in the graph is considered as the source(s) and the sink (t) of a flow network. The minimum s-t cut of the low network is determined. According to some embodiments, the minimum source-sink cut of the flow network is determined using Dinic's algorithm. This process is repeated for each other pairing of vertices in the graph. In the case of an N-vertex graph, S1010 generates N*(N−1)/2 possible source-sink cuts.

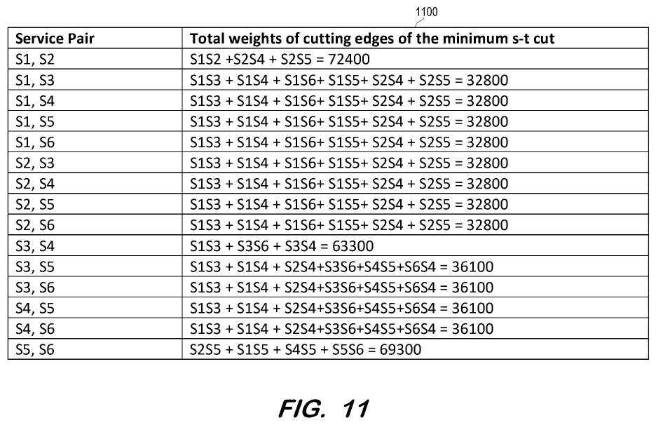

FIG. 11 illustrates table 1100 specifying the minimum s-t cut for each pair of microservices represented in graph 900. For example, the minimum s-t cut for microservices S1, S2 cut across edges S1S2+S2S4+S2S5. Table 1100 also shows the total weights of the edges of each minimum s-t cut. Continuing the above example, the total weights of the edges S1S2+S2S4+S2S5=72400.

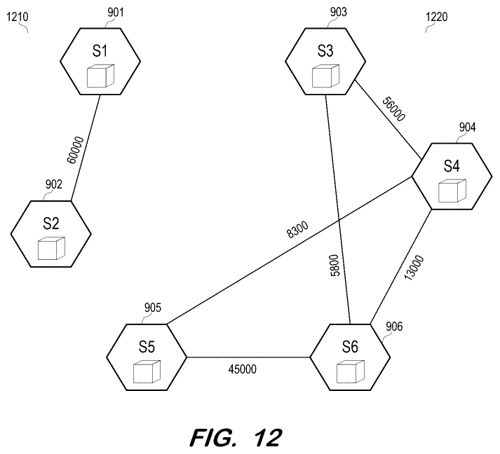

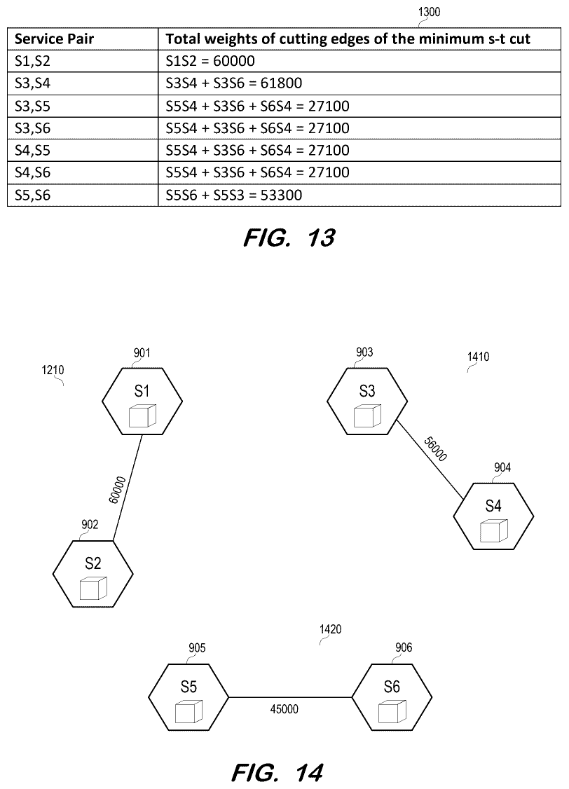

At S1020, the graph is cut along the minimum s-t cut associated with the minimum total edge weights. In the example of table 1100, the minimum s-t cut associated with the minimum total edge weights is S1S3+S1S4+S1S6+S1S5+S2S4+S2S5=32800. Cutting graph 900 along this minimum s-t cut results in sub-graphs 1210 and 1220 of FIG. 12.

At S1030, it is determined whether the number of sub-graphs equals K, the desired number of sub-graphs. It will be assumed that K is 3 for the purposes of the present example but embodiments are not limited thereto. Since only two sub-graphs currently exist, flow proceeds to S1040.

At S1040, and for each sub-graph including more than one vertex, the minimum source-sink cuts of flow networks including each pair of vertices as source and sink are determined. Next, at S1050, the minimum s-t cut associated with the minimum total edge weights is determined and the corresponding sub-graph is cut along this minimum s-t cut.

Table 1300 specifies the minimum s-t cut for each pair of microservices represented in each of sub-graphs 1210, 1220, and the total weights of the edges of each minimum s-t cut. The minimum s-t cut associated with the minimum total edge weights is s5s4+s3s6+s6s4=27100. Sub-graph 1220, which includes these edges, is cut into two sub-graphs along these edges, resulting in sub-graphs 1210, 1410 and 1420 of FIG. 14.

At S1020, the graph is cut along the minimum s-t cut associated with the minimum total edge weights. In the example of table 1100, the minimum s-t cut associated with the minimum total edge weights is S1S3+S1S4+S1S6+S1S5+S2S4+S2S5=32800. Cutting graph 900 along this minimum s-t cut results in sub-graphs 1210 and 1220 of FIG. 12.

Flow then returns to S1030. At S1030, it is determined that the number of sub-graphs equals K. Accordingly, flow proceeds to S1060 to assign microservices of each sub-graph to a respective group. Continuing the example, microservices S1 and S2 are assigned to a first group, microservices S3 and S4 are assigned to a second group, and microservices S5 and S6 are assigned to a third group. Then every group contains a limited count of services that have the closest business relationships. These services should be deployed at the same node or the nearby nodes of the same rack or zone. We can adjust the deployment by the comprehensive consideration of business estimation and clustering results.

Returning to process 400, the groups may be presented to an administrator at S460. Presentation of the groups may proceed in any suitable manner. In some embodiments, an application which executes process 400 may present a user interface indicating the determined groups and the microservices assigned to each group.

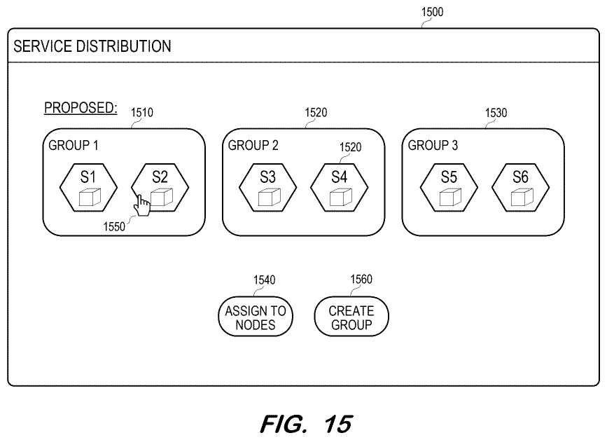

FIG. 15 is a view of user interface 1500 presented at S460 according to some embodiments. User interface 1500 may comprise a Web page presented by a Web browser of a computing device, an interface of a client application executing in a Web browser of a computing device and in communication with a corresponding backend application, an interface of a client application executed by a computing device, etc.

User interface 1500 presents groups 1510, 1520 and 1530. Group 1510 includes icons representing microservices S1 and S2, group 1520 includes icons representing microservices S3 and S4, and group 1530 includes icons representing microservices S5 and S6. If the user approves of the presented groups, the user selects Selection of Assign to Nodes control 1540. Flow therefore proceeds to S480, at which the microservices of each group are deployed to one or more respective nodes which are proximate to one another. For example, the microservices of a group may be deployed to a single node, to different nodes located on a same datacenter rack, to different nodes located in a same datacenter, etc.

If the user does not approve of the presented groups, flow may proceed to S490 to modify the groups. According to the example of FIG. 15, a user may operate cursor 1550 to drag an icon representing a microservice from one group to another group. The user may also or alternatively select Create Group control 1560 to create a new group into which one or more microservice icons may be dragged. Once the groups are suitably modified, flow may proceed to S480 to assign the microservices of each group to appropriate nodes.

According to some embodiments, the deployed microservices are executed to serve incoming requests and generate call logs as described with respect to S420. Network delays of each remote call and aggregate delay values may be determined based on the call logs as described above. The aggregate values may be compared with the aggregate values determined from the prior microservice deployment distribution to determine any changes to network latency due to the new deployment distribution.

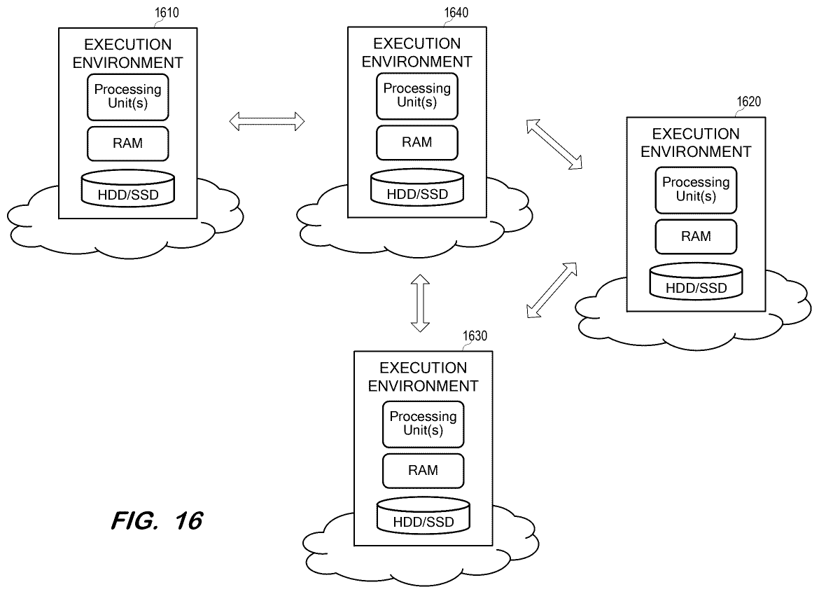

FIG. 16 illustrates a cloud-based deployment according to some embodiments. The illustrated components may comprise cloud-based compute resources residing in one or more public clouds providing self-service and immediate provisioning, autoscaling, security, compliance and identity management features.

Execution environments 1610-1640 may comprise servers or virtual machines of a Kubernetes cluster. Execution environments 1610-1640 may support containerized applications which provide one or more services to users. Execution environments 1610 and 1620 may execute, respectively, a gateway and a central database for collecting call logs, and execution environments 1630 and 1640 may execute microservices of a microservice-based application as described herein.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of networks and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable media. Such media may include, for example, a hard disk, a DVD-ROM, a Flash drive, magnetic tape, and solid-state Random Access Memory (RAM) or Read Only Memory (ROM) storage units. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A system comprising:
a memory storing executable program code; and
one or more processing units to execute the executable program code to cause the system to:
receive metadata of remote calls between a plurality of microservices deployed to first respective nodes;
for each pair of the plurality of microservices, determine a total payload size based on metadata of remote calls between the pair of the plurality of microservices;
generate a graph including a vertex associated with each microservice and an edge between each pair of vertices, where each edge is weighted based on the total payload size determined for the pair of microservices associated with the vertices the edge is between;
divide the vertices into a plurality of groups based on the graph, at least one group including two or more vertices; and
for each of the plurality of groups, deploy the microservices associated with the vertices of the group to a same node or proximate nodes.

2. The system of claim 1, wherein deployment of the microservices comprises:
presentation of the microservices associated with each group; and
reception of an instruction to associate a microservice associated with a first group with a second group.

3. The system of claim 2, wherein deployment of the microservices comprises:
reception of an instruction to create a new group and to associate a microservice associated with a third group to the new group.

4. The system of claim 1, wherein division of the vertices into a plurality of groups based on the graph comprises:
for each pair of vertices in the graph, determine a flow network including a first vertex of the pair as a source and a second vertex of the pair as a sink;
determine a minimum source-sink cut of each flow network;
determine one of the minimum source-sink cuts having a minimum sum of cut edge weights; and
split the graph into first sub-graphs along the one minimum source-sink cut.

5. The system of claim 4, wherein division of the vertices into a plurality of groups based on the graph comprises:
determine that the number of first sub-graphs is less than a minimum desired number of subgraphs; and
in response to the determination that the number of first sub-graphs is less than a minimum desired number of subgraphs:
for each pair of vertices in each of the first sub-graphs, determine a second flow network including a first vertex of the pair as a source and a second vertex of the pair as a sink;
for each sub-graph, determine a second minimum source-sink cut of each second flow network;
for each sub-graph, determine one of the second minimum source-sink cuts having a second minimum sum of cut edge weights; and
for each sub-graph, split the sub-graph along the one of the second minimum source-sink cuts.

6. The system of claim 4, wherein deployment of the microservices comprises:
presentation of the microservices associated with each group; and
reception of an instruction to associate a microservice associated with a first group with a second group.

7. The system of claim 6, wherein deployment of the microservices comprises:
reception of an instruction to create a new group and to associate a microservice associated with a third group to the new group.

8. A method comprising:
for each pair of a plurality of microservices deployed to first respective nodes, determining a total payload size of requests and responses between the pair of the plurality of microservices over a time period;
generating a graph including a vertex associated with each microservice and an edge between each pair of vertices, where each edge is weighted based on the total payload size determined for the pair of microservices associated with the vertices the edge is between;
dividing the vertices into a plurality of groups based on the graph, at least one group including two or more vertices; and
for each of the plurality of groups, deploying the microservices associated with the vertices of the group to a same node or proximate nodes.

9. The method of claim 8, wherein deploying the microservices comprises:
presenting the microservices associated with each group; and
receiving an instruction to associate a microservice associated with a first group with a second group.

10. The method of claim 9, wherein deploying the microservices comprises:
receiving an instruction to create a new group and to associate a microservice associated with a third group to the new group.

11. The method of claim 8, wherein dividing the vertices into a plurality of groups based on the graph comprises:
for each pair of vertices in the graph, determining a flow network including a first vertex of the pair as a source and a second vertex of the pair as a sink;
determining a minimum source-sink cut of each flow network;
determining one of the minimum source-sink cuts having a minimum sum of cut edge weights; and
splitting the graph into first sub-graphs along the one minimum source-sink cut.

12. The method of claim 11, wherein dividing the vertices into a plurality of groups based on the graph comprises:
determining that the number of first sub-graphs is less than a minimum desired number of subgraphs; and
in response to determining that the number of first sub-graphs is less than a minimum desired number of subgraphs:
for each pair of vertices in each of the first sub-graphs, determining a second flow network including a first vertex of the pair as a source and a second vertex of the pair as a sink;
for each sub-graph, determining a second minimum source-sink cut of each second flow network;
for each sub-graph, determining one of the second minimum source-sink cuts having a second minimum sum of cut edge weights; and
for each sub-graph, splitting the sub-graph along the one of the second minimum source-sink cuts.

13. The method of claim 11, wherein deploying the microservices comprises:
presenting the microservices associated with each group; and
receiving an instruction to associate a microservice associated with a first group with a second group.

14. The method of claim 13, wherein deploying the microservices comprises:
receiving an instruction to create a new group and to associate a microservice associated with a third group to the new group.

15. One or more computer-readable media storing program code executable by a computing system to execute operations comprising:
determining a total payload size of requests and responses between each pair of a plurality of microservices deployed to first respective nodes;
generating a graph including a vertex associated with each of the plurality of microservices and an edge between pairs of vertices, where edges are weighted based on the total payload size determined for the pair of microservices associated with the vertices the edge is between;
dividing the vertices into a plurality of groups based on the graph, at least one group including two or more vertices; and
for at least one of the plurality of groups, deploying the microservices associated with the vertices of the group to a same node.

16. The one or more computer-readable media of claim 15, wherein deploying the microservices comprises:
presenting the microservices associated with each group; and
receiving an instruction to associate a microservice associated with a first group with a second group.

17. The one or more computer-readable media of claim 16, wherein deploying the microservices comprises:
receiving an instruction to create a new group and to associate a microservice associated with a third group to the new group.

18. The one or more computer-readable media of claim 15, wherein dividing the vertices into a plurality of groups based on the graph comprises:
for each pair of vertices in the graph, determining a flow network including a first vertex of the pair as a source and a second vertex of the pair as a sink;
determining a minimum source-sink cut of each flow network;
determining one of the minimum source-sink cuts having a minimum sum of cut edge weights; and
splitting the graph into first sub-graphs along the one minimum source-sink cut.

19. The one or more computer-readable media of claim 18, wherein dividing the vertices into a plurality of groups based on the graph comprises:
determining that the number of first sub-graphs is less than a minimum desired number of subgraphs; and
in response to determining that the number of first sub-graphs is less than a minimum desired number of subgraphs:
for each pair of vertices in each of the first sub-graphs, determining a second flow network including a first vertex of the pair as a source and a second vertex of the pair as a sink;
for each sub-graph, determining a second minimum source-sink cut of each second flow network;
for each sub-graph, determining one of the second minimum source-sink cuts having a second minimum sum of cut edge weights; and
for each sub-graph, splitting the sub-graph along the one of the second minimum source-sink cuts.

20. The one or more computer-readable media of claim 18, wherein deploying the microservices comprises:
presenting the microservices associated with each group; and
receiving an instruction to associate a microservice associated with a first group with a second group.
